(19) United States
(12) Patent Application Publication
(10) Pub. No.: US 2004/0172270 A1
(43) Pub. Date: Sep. 2, 2004

(54) Admission control method and system thereof, and facility reservation confirmation method and system thereof

(75) Inventors: Toyokazu Sugimoto, Kawasaki (JP); Minoru Ashizawa, Tokyo (JP); Atsushi Ito, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/722,331

(22) Filed: Nov. 24, 2003

(30) Foreign Application Priority Data
Nov. 29, 2002 (JP) 2002-349274

(51) Int. Cl. G06F 17/60

(52) U.S. Cl. 705/1

(57) ABSTRACT

When an information memory element such as an RF-ID tag is mounted in an admission ticket as buried therein to perform individual identification (ID) control over the admission ticket, smooth gate passage control of a visitor can be realized. A center server or an in-site server controls to the admission or refusal of entrance in a facility on the basis of a relationship between an admission ticket ID printed on one paper sheet of the admission ticket and an element ID unique to the RF-ID tag as well as the current status of the admission ticket ID. And the facility set as reserved can be confirmed by the user on an in-site reservation terminal.

### BACKGROUND OF THE INVENTION

1. Field of the Invention

The present invention relates to an admission ticket which is required when a visitor wants to enter an event site or the like, an admission control method and system, and a facility reservation confirming method and system.

2. Description of the Related Art

Admission of entrance into an event site such as a concert has been so far judged on the basis of a ticket medium. Sales or reservation of the admission ticket is made mainly by ticket selling agents such as play guides or convenient stores.

The same holds true for amusement park. For an amusement park, reservation of entrance into theme halls or attraction facilities located as dispersed in the park is conducted by an already-established reservation method, that is, by a visitor who inserts an admission ticket into a ticket issuing machine installed in the vicinity of a facility which the visitor wants to enter and gets a reservation ticket. However, the visitor cannot specify an entrance time. Further, the reservation undergoes under the restraint that the reservation is allowed after use of a previously-used facility or a constant time after the use of the facility (only one location can be reserved per person).

There has been suggested an electronic ticket system for controlling admission on the basis of member data stored in an IC card issued as a membership card. More in detail, as cited in JP-A-2002-259860, a gate machine installed at the entrance of a park reads out a member number stored in a membership card. And when determining a coincidence between the read-out member number and member number information held in a gate control server, the gate machine controllably admits the entrance of the member visitor. Thereby ticket forging or resale can be prevented because of the absence of a ticket as a paper medium.

### SUMMARY OF THE INVENTION

In such a conventional admission control method as mentioned above, since the ticket is not used as a medium, ticket missing, forging or resale can be prevented. However, this also requires the issuance procedure of the membership card and management thereof, which imposes the additional cost.

Meanwhile, now that the internet environment is upgraded and information storage techniques for storing information on IC card or the like are advanced, any person can carry an electronic ticket. An attempt to store information on the electronic ticket, e.g., in a non-contact type information memory chip with excellent security has been made to substitute such electronic tickets for paper tickets so far used.

In view of the above circumstances and background art, the present invention was made. It is therefore an object of the present invention to provide an admission ticket, an admission control method and system, and a facility reservation confirming method and system, which can realize admission control based on paper admission ticket by electronically processing the paper ticket as an electronic ticket.

Another object of the present invention is to provide an admission ticket, an admission control method and system, and a facility reservation confirming method and system, which allows reservation of a plurality of facilities at a time and confirmation of reservation contents required in connection with the reservation, by removing such conventional restriction as one location per one person.

A further object of the present invention is to provide an admission ticket, an admission control method and system, and a facility reservation confirming method and system, which are convenient even not only to users who use an event place or site but also to persons who controls and manages the event site.

The above objects of the present invention can be solved by burying an information memory element such as an RF-ID (Radio Frequency IDentification) tag in an admission ticket and controlling such admission tickets based on individual IDs (identifiers) to thereby smooth passage of a visitor through a gate and to offer services of facility reservation on the same day as reservation application and on its previous day based on the admission ticket. In the previous reservation, a plurality of facilities and time zone information thereof on scheduled days are made through a medium such as Internet; whereas, in the reservation on the same day as the reservation application, the reservation is made through a reservation terminal installed in the site. The contents set as reservation in this way can be confirmed on the terminal installed in the site.

In accordance with the present invention, a ticket made of, e.g., paper can be processed as an electronic ticket, visitor entrance admission into a facility provided in a site can be controlled with use of admission tickets, such a conventional restriction as one-location-per-one-person reservation can be removed with regard to even facility reservation, and confirmation of the reservation contents required in connection with it can also be easily made.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining a communication infrastructure used by an admission control system and a facility reservation confirming system in accordance with an embodiment of the present invention;

FIG. 2 is a diagram for explaining a business model for implementing an admission control method and a facility reservation confirming method in accordance with the present invention and a relationship of its utilization entity;

FIG. 3 is a block diagram of an internal structure of a center server in which the admission control system and facility reservation confirming system are mounted, showing functions thereof;

FIG. 4A shows a data structure of an admission ticket ID-DB;

FIG. 4B shows a data structure of an ID management database;

FIG. 5 shows a data structure of a facility reservation database;

FIG. 6 is a block diagram of an internal structure of an in-site reservation terminal, showing functions thereof;

FIGS. 7A and 7B are flow charts for explaining manufacturing and sales operations of an admission ticket, respectively;

FIGS. 8A and 8B are flow charts for explaining operations in a previous admission reservation mode and in an admission mode, respectively;

FIGS. 9A and 9B are flow charts for explaining operations in an in-site reservation mode and in a facility admission mode, respectively;

FIG. 10 is a flow chart showing a processing procedure of a facility reservation program;

FIG. 11 shows an exemplary reservation screen structure displayed on an in-site reservation terminal 44;

FIG. 12 shows another exemplary reservation screen structure displayed on the in-site reservation terminal 44;

FIG. 13 shows an appearance of an admission ticket;

FIG. 14 is a block diagram showing the internal structure of an RF-ID tag mounted as buried in an admission ticket;

FIG. 15 is a sequence diagram for explaining the operation of the present invention;

FIG. 16 is a flow chart for explaining an error operation during reading of information on an admission ticket; and

FIG. 17 shows a connection relationship among servers and so on when the present invention is implemented.

### DETAILED DESCRIPTION OF THE EMBODIMENTS

An admission ticket, an admission control method, and an in-site facility reservation confirming method and system in accordance with an embodiment of the present invention will be explained in detail. In the present embodiment, it is assumed that an admission ticket made of paper is processed as an electronic ticket, previous reservation is made based on its admission ticket through a communication infrastructure such as the Internet, and base services include gate passage of a site on the same day as reservation application, facility reservation in the site on the same day as the reservation application and gate passage of facilities. Further, the present invention provides a wide range services including attend service for changing service contents according to private user information, customer flow line, operation support such as stay time analysis, and marketing such as facility use statistics, which will be detailed below. In this case, an admission ticket is used in such a facility reservation method that once the admission ticket is purchased or acquired (that is, once the admission ticket is distributed), reservation of one or more facilities (including attractions) installed in a site which a ticket holder can enter can be made. Thus explanation will be made also in this connection with the facility reservation method.

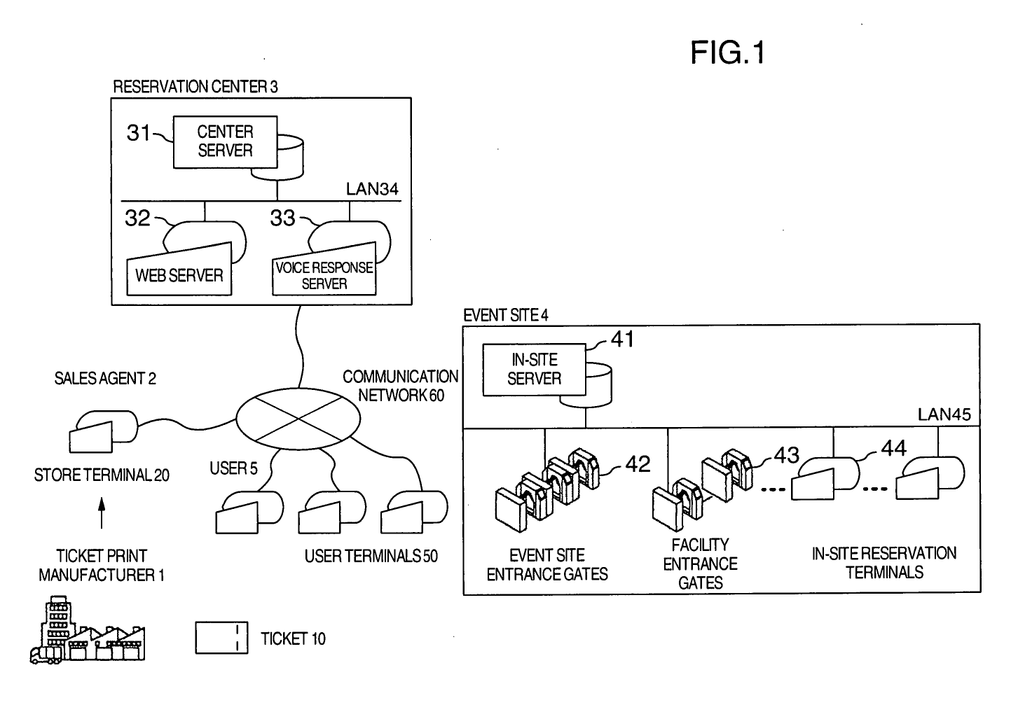

FIG. 1 is a diagram for explaining a communication infrastructure which is used by the admission control system of the present embodiment.

In FIG. 1, an admission ticket 10 printed and manufactured by an admission ticket print manufacturer 1 is distributed to a sales agent 2 such as a play guide or a convenient store under control of an event organizer side (not shown).

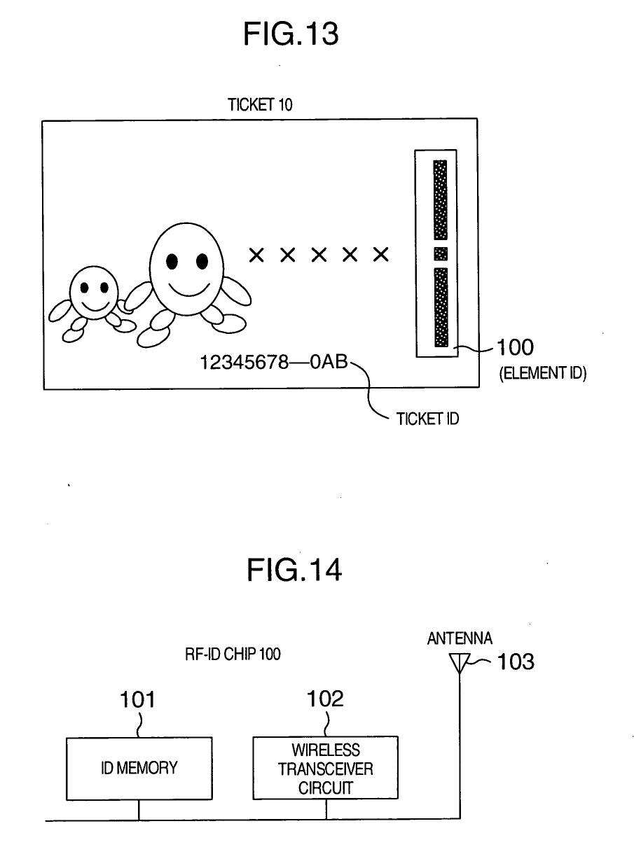

As shown in FIG. 13, printed (marked) on one side of the admission ticket 10 is an admission ticket ID (“12345678-0AB” in the illustrated example, in which “0AB” is an additional code). Further mounted as buried in the admission ticket 10 is an RF-ID tag 100 as a non-contact type information memory element having an element ID which cannot be identified by person but can identified by computer. The admission ticket print manufacturer 1 prints, in addition to the admission ticket ID, a logo mark or character unique to the event or the like onto a white paper sheet piece having the RF-ID tag 100 buried therein, and distributes it to the sales agent 2. And the manufacturer prepares a correspondence table between the admission ticket ID and an element ID of the RF-ID tag 100 in the distributed admission ticket 10. In this case, the element ID corresponds to a “unique first identifier”, while the admission ticket ID corresponds to a “unique second identifier”.

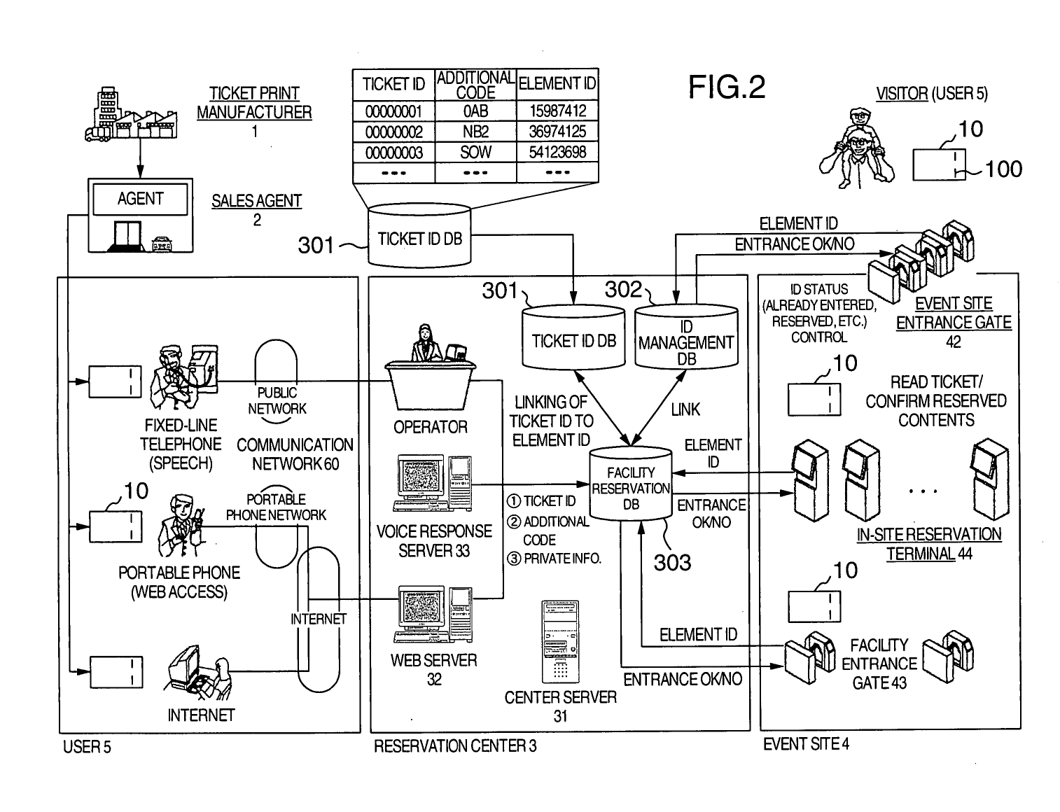

Though not illustrated, printed on the admission ticket 10, are sentences meaning that “the admission ticket ID is required upon entrance into the facility” and meaning that “you should place the ticket 10 on a facility entrance gate 43 (refer to FIG. 2) in a contacted manner or in the vicinity thereof upon entrance in the facility” to cause the gate reader to read the element ID. Such printed sentences are for the purpose of prompting the ticket holder to get a smooth reservation based on the notification or input of the admission ticket ID upon the facility reservation. The sentences are also for the purpose of prompting smooth entrance into a facility (site 4) on a touch & go basis or in a non-stop manner based on the characteristic of the RF-ID tag 100.

As shown in FIG. 14, the RF-ID tag (chip) 100 is a semiconductor circuit which includes, as an example, an ID memory 101 as a 128-bit ROM and a wireless transceiver circuit 102, and which can wirelessly communicate with an external device through an antenna 103. In the present embodiment, it is assumed that an unrewritable ‘μ chip (trade name)’ developed by the same applicant as the present application is employed as the RF-ID tag (chip) 100.

Data capacity of μ chip (trade name) is several ten K bytes and its maximum communication distance is approximately 5-6 meters (it depends on radio wave regulation of countries and regions). When the ‘μ chip (trade name)’ is used, a unique identification number recorded in the ID memory 101 can be read out wirelessly from outside thereof with no battery.

The sales agent 2 sells the admission ticket 10 to a user 5 as a visitor and also manages the sales status thereof using a store terminal 20.

More specifically, the sales agent 2 manages the status of the ticket by reading out the element ID (first identifier) of the RF-ID tag 100 buried in the admission ticket 10 and informing a reservation center 3 of it via a communication network 60. The reservation center 3 manages the sales status of the admission ticket 10 by adding status information indicative of whether or not the admission ticket 10 is already sold in a correspondence table which is prepared by the admission ticket print manufacturer 1, and shows a relationship between the admission ticket ID (second identifier) printed (shown) on the admission ticket 10 and the element ID (first identifier) of the RF-ID tag 100 buried in the admission ticket 10.

In this connection, the management of the sales status in the sales agent 2 is not an essential matter in the implementation of the present invention. By managing the sales status in the sales agent 2, reservation of the admission ticket 10 not sold yet can be made. Or when a visitor having the admission ticket 10 not sold yet wants to enter the site 4 (facility), the ticket can be eliminated as an authorized ticket.

The reservation center 3, on the basis of the admission ticket 10 sold to the user 5, not only makes facility reservation but also controls the entrance and exit of visitors through an event site entrance gate 42 and at an entrance gate 43 of each of facilities including a restaurant and installed within the site. The entrance and exit control is considered to be done on the basis of not only gate automatic opening/closing control wherein a visitor who enters or exits through each gate inserts his admission ticket into the admission ticket reader (not shown) installed at each gate, but also manual control wherein a portable admission ticket reader (handy card reader) carried by an attendant reads the ticket.

Also provided in the reservation center 3 are a center server 31 as its core, a web server 32, and a voice response server 33, which are commonly connected via a LAN (local area network) 34.

The facility reservation system according to the present embodiment is mounted in the center server 31. The system has a function of authenticating the admission ticket 10 by receiving the admission ticket ID printed on the admission ticket 10, communicating with a user terminal 50 connected via the communication network 60 after obtaining its authentication, and linking the element ID (element ID held by the center server 31) of the RF-ID tag 100 buried in the admission ticket 10 to the reservation facility name and reservation time zone information in the event site 4 generated through the operation of the user 5 on the user terminal 50 for reservation registration (that is, a function of registering the reservation in a facility reservation database (DB) 303 shown in FIG. 2). In this connection, the authentication may be made after the input of the reservation facility name, and the facility name may be a facility code corresponding to the facility name.

The center server 31 also has a function of, when the user 5 as a visitor wants to enter the event site 4 or a facility in the event site, reading the ID of the RF-ID tag 100 buried in the admission ticket 10 via the entrance gate 43, referring to facility reservation information already registered with use of the element ID as a key, and judging the admission of the user.

This function may be provided in the entrance gates 42 and 43 so that an in-site server 41 executes its function, thus reducing the load of the center server 31 and quickly judging the entrance admission at the gates 42 and 43.

The web server 32 offers an interface with the user terminal 50 such as a computer a browser-built-in, portable telephone connected to the communication network 60 based on an internet protocol (IP); while the voice response server 33 plays a role of a call center for allowing voice speech to be done with a telephone terminal (fixed-line or mobile telephone) connected via the communication network 60. As shown in FIG. 2, reservation by voice speech with the operator of the voice response server 33 can also be made, which will be explained later.

That is, the user 5 can make reservation for facilities in the event site not only via the Internet but also by telephone speech or push button operation. In other words, reservation can be realized based on a prompting display screen and by prompted voice guidance.

With regard to the reservation, the user 5 may be not only a user himself who actually enters the event site 4 using the admission ticket 10 but also an attorney who is asked to get the reservation and a person who makes the ticket reservation to present it to others.

Installed in the event site 4 are the in-site server 41 as its core, the event site entrance gate 42, a plurality of facility entrance gates 43 and many in-site reservation terminals 44, which are commonly connected in a LAN 45. In this case, the in-site server 41, event site entrance gate 42 and facility entrance gates 43 form an admission control apparatus, while the in-site server 41 and in-site reservation terminals 44 form an in-site reservation terminal control apparatus.

The opening and closing of event site entrance gate 42 and facility entrance gates 43 is controlled by the in-site server 41 under control of the center server 31; the in-site reservation terminals 44 are used not only for facility guidance but also by the user 5 who wants to make facility reservation on the same day as his site entrance. The in-site reservation terminal 44 is used for confirming the reservation made by the user 5.

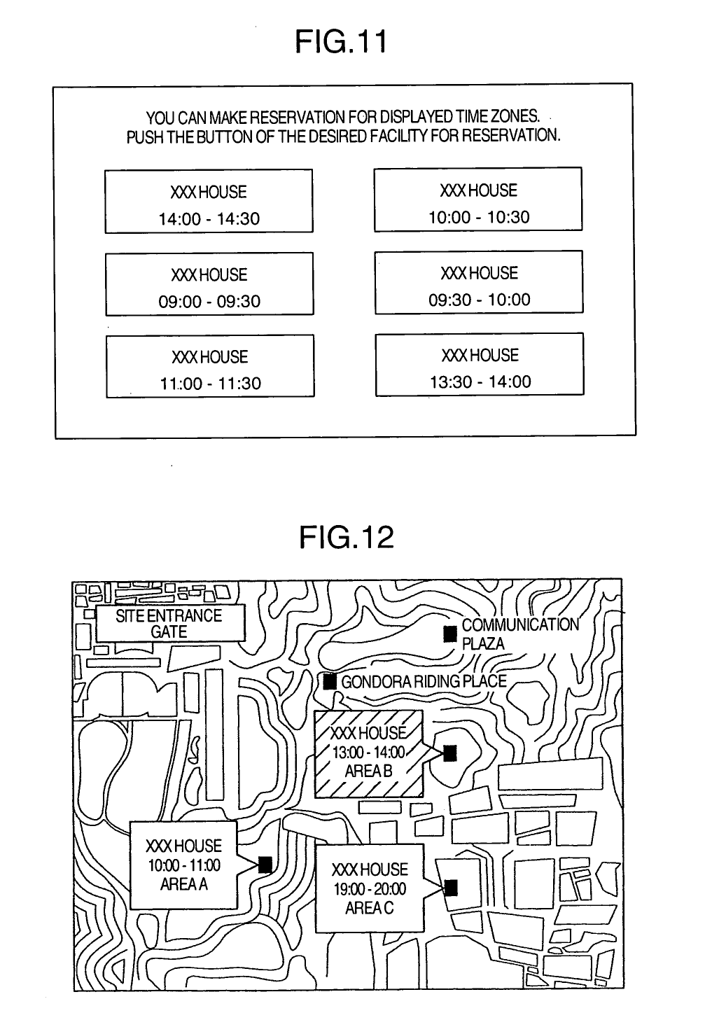

The facility reservation is made on a reservation display screen. Examples of the reservation display screen on the in-site reservation terminal 44 are shown in FIGS. 11 and 12. The facility reservation may also be done by voice speech or by push button operation, as already mentioned above.

Shown in the reservation screen of FIG. 11 are reservation available facilities and time zone information thereof in a button representation. Reservation can be set by selecting and clicking a button A. Also shown in the reservation screen of FIG. 12 are reservation available facilities overlapped with a map. In the screen, already-reserved and not-reserved-yet facilities are shown as distinguished from each other by the different colors or the like of their balloon frames. A touch of the balloon frame enables the reservation to be established. In the latter case, since the in-site facilities and available statuses thereof are visually displayed as associated with each other, operability in the reservation set mode can be enhanced. Details thereof will be explained later.

FIG. 2 is a diagram for explaining a business model for implementing the admission control method and facility reservation confirming method based on the admission ticket 10 in the present embodiment and a relationship of use entity thereof. In the illustrated example, components having the same functions are denoted by the same reference numerals and explanation thereof is omitted.

The admission ticket print manufacturer 1 first forms an admission ticket ID DB 301 by preparing a correspondence table between the admission ticket ID printed on the admission ticket 10 and the element ID of the RF-ID tag 100 buried in the admission ticket 10.

Next, the user 5 purchases the admission ticket 10, e.g., from the sales agent 2, goes directly to its event site 4 and then can enter the site. Or after the user conducted operations necessary for facility reservation (to be explained later), the user goes to the event site 4 and can enter the site. In this connection, the purchase and reservation of the admission ticket 10 itself, as in the conventional case, is completed by the user 5 who accesses the sales agent 2 by telephone, via the Internet or its web site. An exchange number issued at this time or the ID of the user is presented to the sales agent 2 such as a ticket counter or convenient store, and then its ticket fee is paid. Or after payment completion is confirmed based on transfer of the ticket fee or the like, the admission ticket 10 is sent to the user 5 by mail (distribution or delivery). Of course, the user 5 can go to the sales agent 2 and purchase the ticket directly in the site.

The user 5 who got the admission ticket 10 can enter the event site 4 with use of the ticket carried by the user without any reservation on the spot and can use the reserved facility. However, when the user 5 fails to make reservation for the popular facility in the event site 4, he must stand in a line to wait for his entrance order of the facility.

The user places the admission ticket 10 in the vicinity of the event site entrance gate 42 or inserts it into the admission ticket reader built in the event site entrance gate 42. The event site entrance gate 42 in turn reads the element ID of the RF-ID tag 100 buried in the admission ticket 10 and transfers the read data to the reservation center 3 or in-site server 41. Whereby the entrance admission or refusal of the user is judged.

Meanwhile, the user 5 who got the admission ticket 10 may make reservation for the facility of the event site 4 and then go to the event site 4. That is, when the user purchases the admission ticket 10 having different IDs which are identified by computer and person respectively differently, he can make reservation for the facility. Reservation may be realized using fixed-line telephone, mobile telephone, personal computer or the like, as shown in FIG. 2, which will be detailed later. In this connection, ‘purchase’ is one form of distribution or acquirement.

The center server 31 or in-site server 41 refers to the admission ticket ID DB 301 with use of the admission ticket ID printed on the admission ticket 10 as a key, and performs gate control to admit or refuse the entrance into the event site 4.

The admission ticket ID printed on the admission ticket 10 includes a serial number and an additional code. The center server 31 of the reservation center 3 or the in-site server 41 installed in the event site 4 authenticates a combination of the serial number and the additional code entered following the serial number, and gives the entrance admission. The data structure of the admission ticket ID DB 301 is as illustrated, which will be detailed later.

The center server 31 forms an ID management database (DB) 302 in which stored is, in addition to the correspondence table prepared by the admission ticket print manufacturer 1, information about one of statuses of already sold (S), already entered in the event site 4 (E) and already reserved facility (R) for each of the unique admission ticket IDs printed on the admission tickets 10. The center server 31 performs status management over the admission ticket 10 by referring to the ID management DB 302.

The center server 31 also stores in the facility reservation DB 303 the unique element ID of the RF-ID tag 100 buried in the admission ticket 10 and facility reservation information including the reservation facility name and reservation time information registered by the user 5 via the communication network 60.

And the center server 31 or in-site server 41, when the user 5 places the carried admission ticket 10 in the vicinity of the facility entrance gate 43 or inserts it into the gate, refers to the facility reservation DB 303 with use of the unique element ID of the RF-ID tag 100 buried in the admission ticket 10 as a key, and performs gate control to admit the entrance into the facility in the event site 4. When the attendant carries a portable admission ticket reader, the visitor carrying the ticket is required to follow the instruction of the attendant. In this case, the entrance control is manually made according to the result of the admission ticket read by the ticket reader.

Further, the reservation center 3 can provide services different for each user after the facility entrance on the basis of private information entered following the registration of the facility reservation information.

That is, the reservation center 3 can provide a wide range of services including orienteering based on the admission ticket 10, a personal attend service the contents of which is varied according to the private information, operation support such as customer flow line and stay time analysis and marketing such as facility user statistics.

Further, when the admission ticket 10 cannot be read at any of the gates 42 of the event site 4 or at any of the gates 43 installed in the site, the reservation center 3 can update the admission ticket ID DB 301 and facility reservation DB 303 with use of the admission ticket ID printed on the admission ticket 10 as a key and can perform a procedure for ticket reissuance.

In this case, it is assumed that the number of facilities reservable at a time is about 10 and the reservation has two types, i.e., previous reservation made prior to the site attendance and on-the-day reservation made in the site on that day. The previous reservation is made via the Internet or web site or by operator contact. The input of the admission ticket ID printed on the admission ticket 10 is indispensable but the private information is arbitrary. The on-the-day reservation is made by the in-site reservation terminal 44 or by operator contact. The manual input of the user 5 as a visitor is not required and it is only required for the element ID of the RF-ID tag 100 buried in the admission ticket 10 to be read.

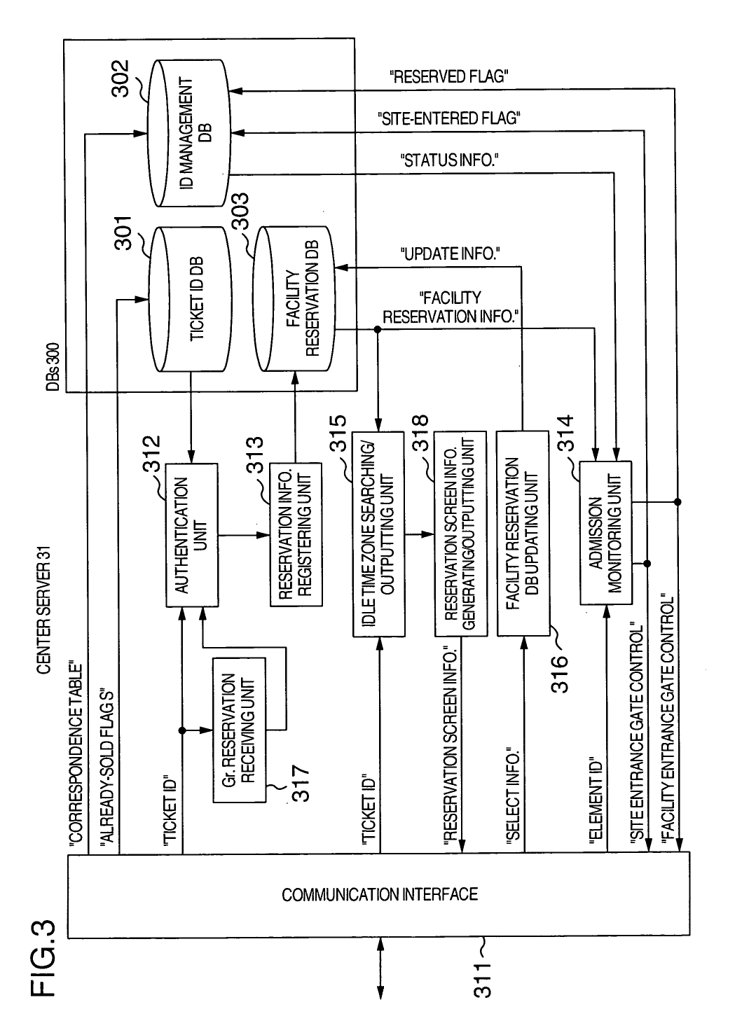

FIG. 3 is a block diagram of an functional internal structure of the center server 31 in which the admission control system or reservation confirming system in accordance with the present embodiment is mounted.

As shown in FIG. 3, the center server 31 includes a communication interface 311, an authentication unit 312, a reservation information registering unit 313, an admission monitoring unit 314, an idle time zone searching/outputting unit 315, a facility reservation DB updating unit 316, a group (Gr.) reservation receiving unit 317, a reservation screen information generating/outputting unit 318, and various sorts of DBs 300.

In this connection, when the entrance admission is judged by the in-site server 41, the admission monitoring unit 314 is mounted in the in-site server 41. In this case, the same also holds true for the ID management DB 302 as one of various sorts of DBs 300 to be explained later.

The communication interface 311 offers an interface with the store terminal 20 of the sales agent 2, in-site server 41 in the event site 4, in-site reservation terminals, and user terminals 50 for the user 5, which are all connected via the communication network 60 and via the Internet or LAN in this case. Thus, it is assumed that TCP/IP (Transmission Control Protocol/Internet Protocol) is mounted in the communication interface 311.

The authentication unit 312 has a function of authenticating the justification of the admission ticket 10 by receiving the unique admission ticket ID printed (marked) on the admission ticket 10. The reservation information registering unit 313 has a function of obtaining the authentication by the authentication unit 312, communicating with the user terminal 50, linking the unique element ID of the information memory element buried in the admission ticket 10 to the reservation facility name and reservation time zone information generated when the user 5 operates the user terminal 50, and registering the relationship in the facility reservation DB 303. In this case, the facility reservation DB 303 having such registration as mentioned above is used for facility admission control (for example, to judge entrance admission or refusal or to estimate the number of visitors).

The admission monitoring unit 314, when a visitor enters the site or facility, has a function of reading out the element ID of the admission ticket 10 through the event site entrance gate 42 or entrance gate 43, referring to the facility reservation information registered in the facility reservation DB 303 with use of the ID as a key, and admitting or inhibiting the entrance of the event site entrance gate 42 or entrance gate 43 by opening or closing the gate. The function may be provided, e.g., to the gate sides 42 and 43 (in-site server 41) by dispersing the load of the center server 31, as already mentioned earlier.

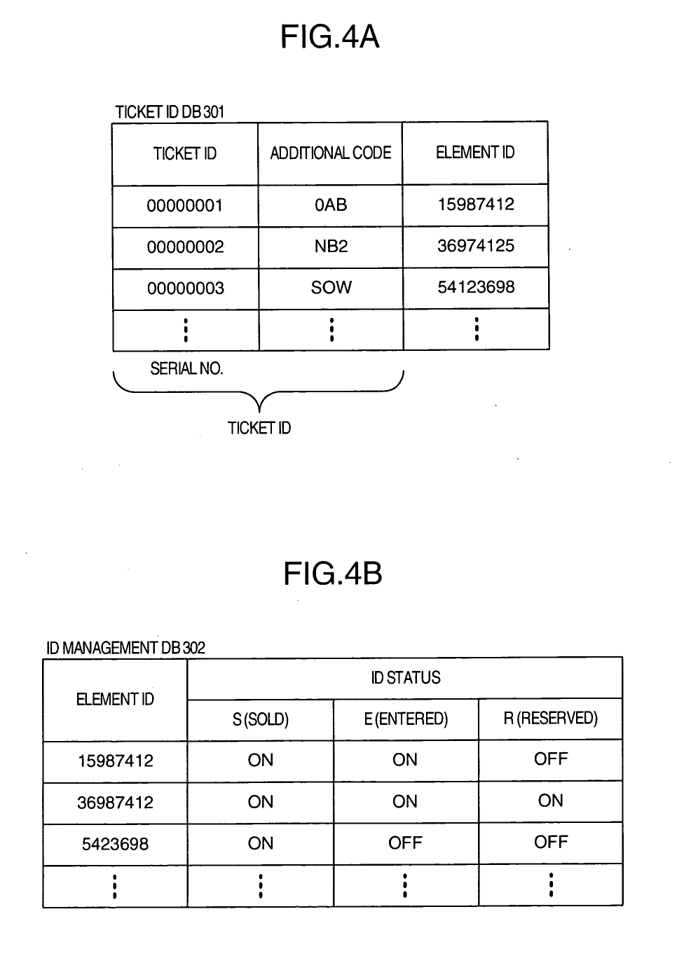

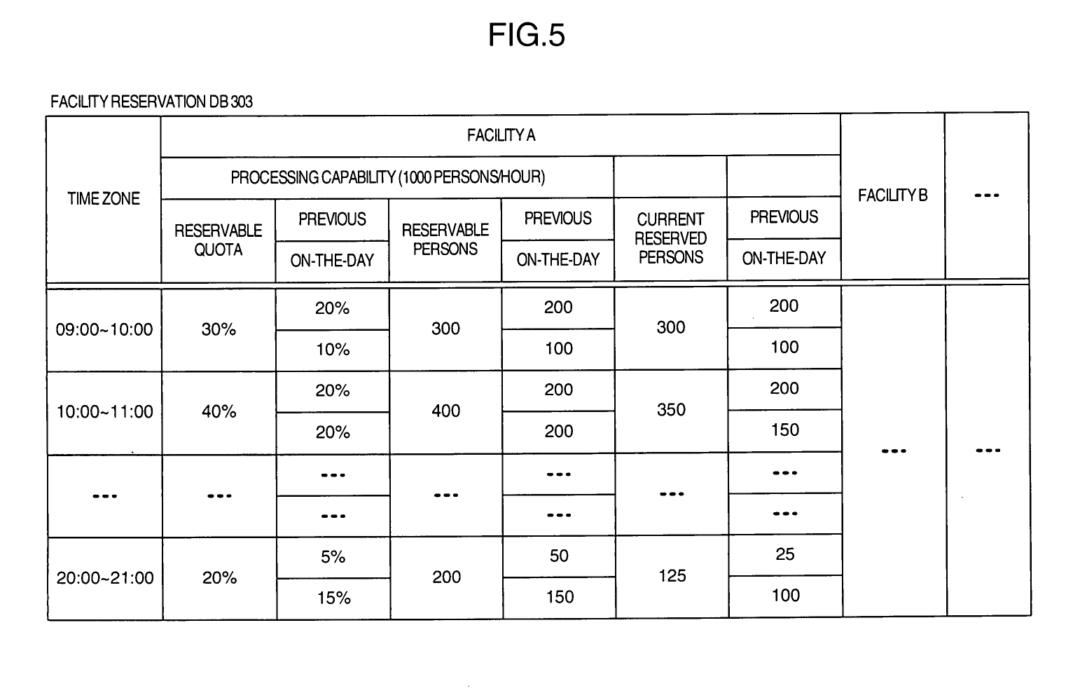

In this case, various sorts of DBs 300 include an admission ticket ID DB 301, an ID management DB 302 and a facility reservation DB 303. The data structures of the admission ticket ID DB 301, ID management DB 302 and facility reservation DB 303 are shown as an example in FIG. 4A, FIG. 4B and FIG. 5 respectively.

In FIG. 4A, the admission ticket ID DB 301 contains fields of admission ticket ID (serial number part of the admission ticket ID), additional code (added part of the admission ticket ID) and element ID.

In FIG. 4A, the letters “ticket ID” written in the field of the table is an admission ticket ID (serial number) in a narrow sense, and the letters “ticket ID” written outside of the table is an admission ticket ID (serial number plus additional code) in a broad sense.

In this case, the admission ticket ID has a 1:1 relationship with the element ID. And, the admission ticket ID is created on the basis of a correspondence table prepared when the admission ticket print manufacturer 1 prints the admission ticket ID and the contents of an event on a white paper admission ticket 10 having the RF-ID tag 100 buried therein.

Further, since the admission ticket ID (serial number part) is a line of sequential numbers, the additional code consists of, e.g., 3 digit alphanumerics. As will be explain later, since a correspondence relationship between the admission ticket ID (serial number part) and additional code inputted when reservation is made via the Internet or the like is authenticated, the user 5 not having the admission ticket 10 can be prevented from making reservation out of mischief or unauthorizedly.

In FIG. 4B, the ID management DB 302 contains fields of the element ID and ID status information. The ID status information has three statuses of already sold (S), already entered (E) and already reserved (R). It is assumed in this case that the status S is set by the sales attorney, the status E is by the event site entrance gate 42 or entrance gate 43, and the status R is by the center server 31 or in-site reservation terminals 44.

When unadmittable ID is listed, the element ID of the admission ticket 10 which was once used to enter the site, is set as unadmittable ticket. Further, the single presence of the ID management DB 302 is not indispensable conditions, and the status information filed may also be added to the admission ticket ID DB 301. In this case, such a consideration is required as necessary that a copy of the DB 301 is prepared in the in-site server 41 of the event site 4 so that the event site entrance gate 42, entrance gate 43 and in-site reservation terminals 44 can immediately access the DB.

FIG. 5 shows part of the facility reservation DB 303, in which the number of persons reservable for each facility entrance time zone is previously set by the operator or the like and the number of persons already reserved at the current time point is sequentially stored. Though not shown in FIG. 5, the facility reservation DB 303 is also such a database that the reservation facility name and reservation time zone information thereof are stored (registered) as associated with the element ID.

The facility reservation DB 303 (see FIG. 5) contains fields of a processing capability and the number of reservations for each facility installed in the event site and for each time zone. The processing capability field has reservable quotas (%) on that day and on the previous day and reservable number (number of persons) previously set.

Turning again to FIG. 3, the idle time zone searching/outputting unit 315 has a function of, in the previous reservation mode, receiving a reservation input on the entrance date through the user terminal 50, referring to the facility reservation DB 303, searching for a time zone in which the current number of persons already reserved for the facility on the same day as the entrance is smaller than the number of reservable persons, and outputting it. In the on-the-day reservation mode, further, the idle time zone searching/outputting unit 315 has a function of receiving a reservation input of the desired entrance facility from the in-site reservation terminal 44 by the user 5 who causes the admission ticket 10 to be read by the in-site reservation terminal 44 and who operates the in-site reservation terminal 44, referring to the facility reservation DB 303, searching for an idle time zone in which the current number of persons already reserved for the facility on the same day as the entrance is smaller than the number of reservable number, and outputting it.

In the previous reservation mode, the facility reservation DB updating unit 316 has a function of registering time zone information selected by the user 5 from idle time zones in the facility reservation DB 303 as associated with the element ID, and updating the number of persons already reserved at the current time point. In the on-the-day reservation mode, the facility reservation DB updating unit 316 has also a function of registering time zone information selected from idle time zones in the facility reservation DB 303 as associated with the RF-ID element ID of buried in the admission ticket 10, and updating the number of persons already registered on that day at the current time point.

Meanwhile, the group reservation receiving unit 317 has a function of receiving the respectively-unique admission ticket IDs printed on a predetermined number of the admission tickets 10 and allowing an reservation input only for the same facility and the same time zone.

In the facility reservation mode, the reservation screen information generating/outputting unit 318 has a function of referring to the facility reservation DB 303 regardless of the previous day or the day, generating display screen information in such a form the user 5 can select a reservable facility name and time zone information therefore, and providing the screen information onto the user terminal 50 or in-site reservation terminal 44.

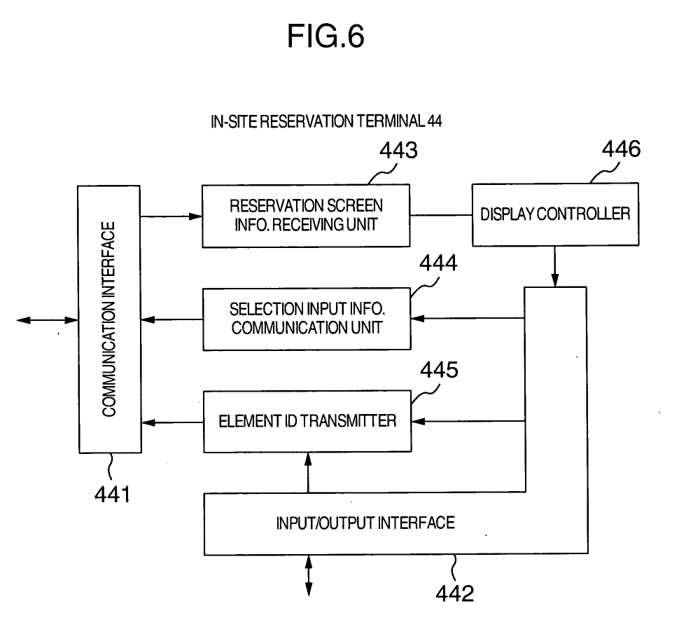

FIG. 6 is a functional block diagram of the internal structure of the in-site reservation terminal 44 installed in an event site.

The in-site reservation terminals 44 are installed as dispersed in the event site and have each a liquid crystal touch panel as hardware (not shown). The in-site reservation terminal 44 also has a tag reader (admission ticket reader, not shown) for wirelessly reading the RF-ID tag 100 buried in the admission ticket 10 as its peripheral device.

The in-site reservation terminal 44 has a communication interface 441, an input/output interface 442, a reservation screen information receiving unit 443, a selection input information communication unit 444, an element ID transmitter 445, and a display controller 446.

The communication interface 441 forms an interface with the in-site server 41 installed in the event site 4. Since the communication interface 441 is connected with the in-site server 41 via the LAN, TCP/IP is mounted in the interface. The input/output interface 442 forms an interface with the liquid crystal touch panel or tag reader connected as the peripheral device. The input/output interface 442 functions to input or display data inputted or outputted via the liquid crystal touch panel or to supply the element ID read through the tag reader to the element ID transmitter 445.

The reservation screen information receiving unit 443 functions to communicate with the center server 31 when the RF-ID tag 100 buried in the admission ticket 10 is placed close to the tag reader or inserted thereinto, and to receive associated reservation screen information from the center server 31 via the communication interface 441 in such a form that the user can select a reservable facility name and its reservation time zone.

The selection input information communication unit 444 displays the reservation screen information received from the reservation screen information receiving unit 443 to input a selection input for the facility reservation by the user, and transmits the selection input to the center server 31 via the communication interface 441, LAN 45, in-site server 41, and communication network 60.

The display controller 446 has a function of generating display data to expand the reservation screen information received from the reservation screen information receiving unit 443, to display the current location and an array of facilities installed close thereto in the form of a map, and to display the already-reserved facility as distinguished from the other facilities; and displaying the display data on the liquid crystal touch panel via the input/output interface 442.

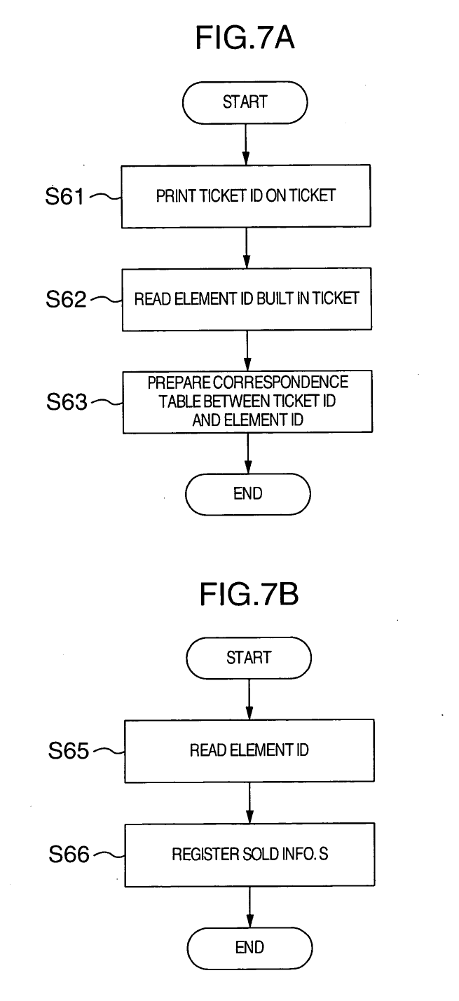

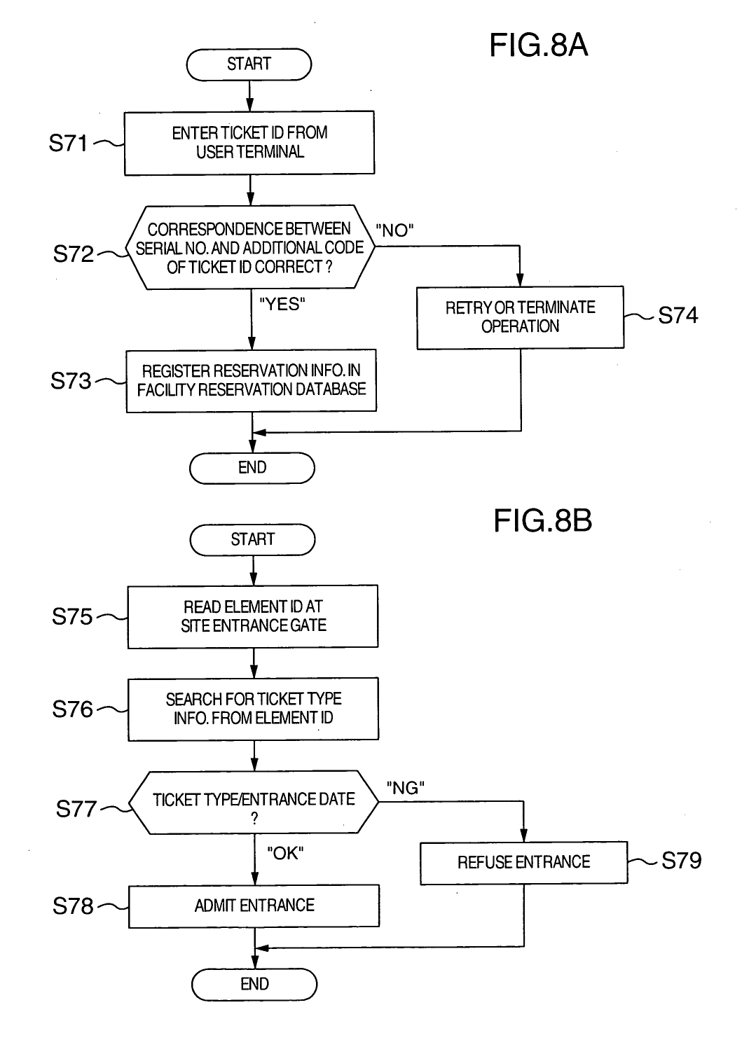

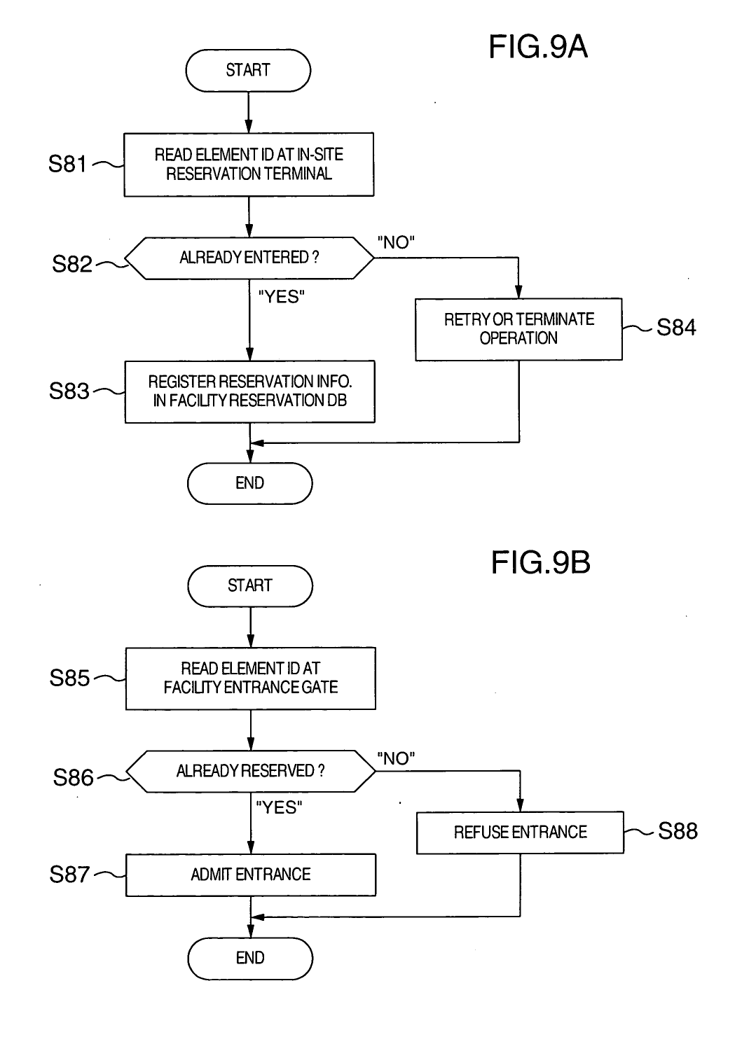

FIGS. 7A, 7B, 8A, 8B, 9A and 9C are flow charts for explaining the operation of the present embodiment, showing the admission ticket manufacturing procedure (FIG. 7A), admission ticket sales procedure (FIG. 7B), previous admission ticket reservation procedure (FIG. 8A), admission procedure (FIG. 8B), in-site reservation procedure (FIG. 9A) and facility admission procedure (FIG. 9B), respectively.

Explanation will be made as to the operation of the present embodiment by referring to the flow charts of FIGS. 7A, 7B, 8A, 8B, 9A and 9C.

The operation of the admission ticket manufacturing procedure will be explained by referring to the flow chart of FIG. 7A.

The admission ticket print manufacturer 1 first prints information associated with the event including the admission ticket ID on one surface of a paper-made admission ticket having the RF-ID tag 100 buried therein (step S61). Though the admission ticket ID to be printed (displayed) consists of a serial number, a ticket type and an additional code as already mentioned above, it is also considered to add even a ticket type code (one day ticket or half day ticket) or the like.

The admission ticket print manufacturer 1 also reads the element ID of the RF-ID tag 100 buried in the admission ticket using an exclusive terminal (not shown) (step S62), prepares a correspondence table between the now-read element ID and (step S63) and the admission ticket ID, and forms the admission ticket ID DB 301.

By referring to the flow chart of FIG. 7B, explanation will be made as to the operation of the store terminal 20 in the admission ticket sales procedure.

In the sales agent 2 such as a play guide or a convenient store, the store terminal 20 equipped in the play guide or store to sell the admission ticket to the user 5 reads the element ID of the RF-ID tag 100 buried in the admission ticket 10 (step S65). And the store terminal 20 registers already-sold information (S) as status information in the entry of the corresponding element ID of the admission ticket ID DB 301 previously prepared (step 66). The status information now added is reflected not only on the admission ticket ID DB 301 but also on the ID management DB 302.

In this connection, the sales agent 2 is an agent of the event organizer in the sales of the admission ticket 10, but it is also considered for the agent not to sell the printed admission ticket 10 but to print the event information including the admission ticket ID on a white admission ticket 10 having the RF-ID tag 100 buried therein and then sell it. In this case, it goes without saying that the agent is required to reach an agreement with the event organizer and also to prepare the exclusive terminal.

The operation of the server center in the previous reservation procedure by referring to the flow chart of FIG. 8A.

The user 5 operates the user terminal 50 such as a portable telephone terminal having a browser application built therein or a personal computer at home to thereby enter the admission ticket ID printed on the purchased admission ticket 10 (step S71). The center server 31 when receiving the admission ticket ID via the communication network 60 and web server 32 authenticates whether or not a relationship between the serial number and additional code of the admission ticket ID is correct (step S72). When obtaining the authentication, the center server 31 registers its reservation information in the facility reservation DB 303 (step S73).

The center server 31 registers the facility reservation information and the element ID corresponding to the authenticated admission ticket ID attached thereto on the basis of reservation facility and reservation time zone information generated when the user 5 operates the user terminal 50 and brows the facility reservation screen (to be explained later).

When failing to obtain the authentication, the center server 31 retries it or terminates its operation (step S64).

As a result, the facility previous reservation service using the admission ticket 10 can be realized and thus a high quality of convenient service can be provided to visitors on the basis of individual ID control of the admission ticket. For reservation, further, when private information is registered, the service contents can also be changed according to the private information. In addition, a facility reservation system with excellent security can be provided while making the most of the feature of the RF-ID tag 100 of hard forging of the ticket of a non-contact type.

In the foregoing embodiment, explanation has been made in connection with only the case where the previous reservation is made via the Internet or web site. However, it is also possible to make the previous reservation by the voice of a telephone terminal (such as a fixed-line telephone) or through the operation of a key telephone (for example, such a reservation according to a voice guide saying that, for example, “tell me your admission ticket ID”). In this case, the operator belonging to the reservation center 3 answers to it and responds it via the voice response server 33. Of course, the facility reservation information, as in the facility reservation mode using the center server 31 via the Internet, is registered in the facility reservation DB 303.

Further, in the previous reservation mode, group reservation becomes possible. That is, the same facility and same time zone can be reserved through the input of the number of group users and through the input of admission ticket IDs of the group users. In this case, the center server receives the input of the respectively-unique admission ticket Ids printed on a predetermined number of admission tickets through the input thereof by a representative of the group users, and allows its reservation input only for the same time zone of the same facility.

Explanation will next be made as to the operation of the center server 31 or event site entrance gate 42 when the user 5 wants to enter the event site 4, by referring to the flow chart of FIG. 8B.

When entering the event site 4, the user is admitted to enter the site by placing the admission ticket in the vicinity of the event site entrance gate 42 or by inserting the ticket into the gate. In the illustrated example, since the RF-ID tag 100 is buried in the admission ticket 10, it is unnecessary for the user to insert the ticket into the gate and it is only required to place the ticket close to the gate. That is, the element ID of the admission ticket 10 having the RF-ID tag 100 buried in the admission ticket is read out by the event site entrance gate 42 (step S75), and the type of the ticket is searched in the admission ticket ID DB 301 by the gate which refers to the admission ticket ID DB 301 based on the read-out element Ids (step S76). In this connection, the searching may be processed by the center server 31 of the reservation center 3 or may be locally processed in the event site 4. In the latter case, however, a copy of the admission ticket ID DB 301 is required.

Further, the admission ticket may be inserted into an admission ticket reader at the event site entrance gate 42, in which case the admission ticket is marked by printing, punching or the like. Since such an admission ticket can be visually observed by the attendant, the illegal resale of the admission ticket once sold can be advantageously prevented.

The entrance date is now checked (step S77). The gate is controlled so that if the ticket is coincided with its entrance date, then the gate admits its entrance (step S78); while, if the ticket is not coincided therewith, then the gate refuses its entrance (step S79). When ticket type information is contained in the admission ticket 10, in addition to the check of the entrance date, the check of the ticket type is also made, and gate control similar to the entrance date is carried out. The ticket type is classified into sorts of one day ticket, half day ticket, adult ticket, children ticket, and so on. Though not illustrated, it is assumed that the ticket type is stored in the admission ticket ID DB 301 as associated with the admission ticket ID.

In this way, when the non-contact RF-ID tag is introduced, the paper admission ticket 10 can be processed as an electronic ticket, and admission or refusal of the entrance of the visitor into the event site 4 can be controlled according to the relationship between the admission ticket ID printed on the paper ticket and the unique element ID of the RF-ID tag and the current status of the admission ticket ID. Thus, smooth gate passage can be realized and a high quality of convenient service with excellent security can be provided. Further, since the facility reservation and the entrance and exit into the event site 4 can be controlled based on the paper admission ticket, the load of such tickets to be imposed on the environment when the tickets are discarded can be lightened (environment friendly).

The operation of the center server 31 or in-site server 41 in the on-the-day reservation within the event site 4 will then be explained by referring to the flow chart of FIG. 9A.

The user 5 places the admission ticket 10 in the vicinity of the in-site reservation terminal 44 or inserts it into a reader part of the terminal, at which time the in-site reservation terminal 44 reads out the element ID of the RF-ID tag 100 buried in the admission ticket 10 (step S81). The read-out element ID is supplied to the in-site server 41 or to the center server 31 of the reservation center 3, which in turn checks the flag information (E) of the ID management DB 302 and judges whether or not the ticket is already admitted (step S82).

When determining or confirming that the ticket is already admitted, the in-site server or the center server registers facility reservation information in the facility reservation DB 303 on the basis of the facility name and time zone information entered by the user 5 while browsing the reservation screen of the liquid crystal touch panel of the in-site reservation terminal 44 (step S83). When failing to confirm that the ticket is already admitted, the in-site server or the center server retries it or terminates its operation (step S84).

In this way, when the non-contact RF-ID tag 100 is introduced, the paper admission ticket 10 can be processed as an electronic ticket, an the possibility or non-possibility of the on-the-day reservation can be controlled according to the relationship between the admission ticket ID printed on the paper and the unique element ID of the RF-ID tag and to the current status of the admission ticket ID. As a result, a high quality of convenient service even with excellent security can be offered. Upon the on-the-day reservation, further, the need for the user to manually enter can be eliminated, it is required for the admission ticket to be read, and it is only for the user to enter a touch input for reservation setting while browsing the reservation screen, thus remarkably increasing easy of its use or its operability.

When the admission ticket is degraded or damaged to such a degree that it becomes difficult for the ticket to be read, it is assumed that, after the ticket is confirmed on the basis of the admission ticket ID as an authorized admission ticket, the old ticket can be exchanged with a new admission ticket in the event site 4. Accordingly, even when an unexpected situation takes place that the admission ticket 10 cannot be used, it can be recovered and convenience can be offered to the user 5. In this case, however, it becomes necessary to update the contents of the admission ticket ID DB 301, ID management DB 302 and facility reservation DB 303.

Explanation will be made as to the operation of the facility entrance gate when the user 5 enters the facility, by referring to the flow chart of FIG. 9B.

The user 5 places the admission ticket 10 carried by the user in the vicinity of the facility entrance gate 43 or inserts it into the reader part of the gate. At this time, the element ID of the RF-ID tag 100 buried in the admission ticket 10 is read out by the gate (step S85). And whether or not the ticket is already reserved is checked by the gate which refers to the facility reservation DB 303 (step S86). Now the reservation facility name and time zone information are examined. If finding a coincidence therebetween, then the entrance gate 43 admits the entrance into the facility (step S87); while if failing to find the coincidence, then the gate controls its opening and closing operation to refuse the entrance (step S88).

When the gate opening/closing control is carried out by the in-site server 41 within the event site, it is required to have a copy of the facility reservation DB 303. When the gate opening/closing control is carried out by the center server 31, it is required to previously obtain a copy of facility reservation data corresponding to the facility reservation on that day. In this case, the check of entrance into the facility is not limited by the gate and may be replaced by the check using the handy type admission ticket reader (tag reader) carried by the attendant. When the facility is a restaurant, the latter is practically desirable.

In this way, when the non-contact RF-ID tag 100 is introduced, the paper admission ticket 10 can be processed as an electronic ticket, and the admission or refusal of entrance into the facility can be controlled according to the relationship among the admission ticket ID printed on the paper sheet, the unique element ID of the RF-ID tag, and the current status of the admission ticket ID. As a result, smooth gate passage can be realized and a high quality of convenient service with excellent security can be offered by combining with private information.

Further, the combination with the private information also enables a wide range of services including a personal attend service wherein the contents of a service in a facility is varied according to the private information, operation support such as customer flow line or stay time analysis, marketing such as facility use statistics.

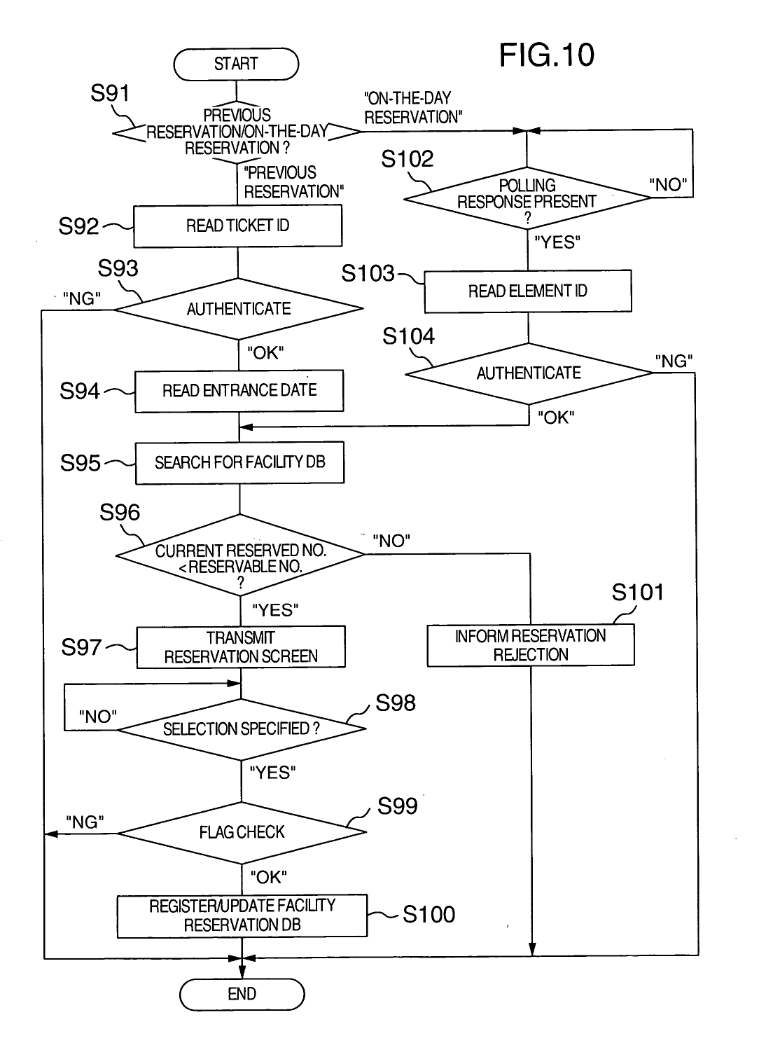

FIG. 10 is a flow chart showing a procedure of the processing operation of a facility reservation program, which will be detailed in connection with facility reservation by referring to the flow chart.

According to the present embodiment, with regard to the facility reservation, both of the previous reservation and on-the-day reservation are possible. The former is made through the Internet or web site; while the latter is made by the in-site reservation terminals 44 installed as dispersed in the site. In any case, the reservation information is set when the user 5 enters the desired facility name and time zone while browsing the reservation screen on the user terminal 50 or in-site reservation terminal 44. In the illustrated example, explanation will be made with reference to the functional block diagram of the center server 31 shown in FIG. 3 and also to the functional block diagram of the in-site reservation terminal 44 shown in FIG. 6.

In the case of the previous reservation (“previous reservation” in step S91), the center server 31 first receives an admission ticket ID entered by the user 5 via the communication network 60 (step S92). At this time displayed on the user terminal 50 is a screen prompting the user to enter the admission ticket ID, saying “Enter the admission ticket ID”. When the center server inputs (receives) the admission ticket ID, a display screen prompting the user to enter the admission ticket ID appears. When the center server inputs (receives) the admission ticket ID, the reservation information registering unit 313 of the center server to be started through the authentication (step S93) of the authentication unit 312. As already mentioned earlier, the authentication may be made later.

After the authentication, the reservation information registering unit 313 inputs entrance desired date information generated when the user 5 prompted to enter by such a screen saying “Enter the entrance desired date” operates the user terminal 50 (step S94), and searches the facility reservation DB 303 (step S95). As a result, the idle time zone searching/outputting unit 315 searches for a facility name having a blank time zone satisfying a relation of “current reservation number<reservation available quota number” and outputs it (step S96). On the basis of the searched and outputted facility name, the reservation screen information generating/outputting unit 318 generates and transmits reservation screen information (contents prompting the user to select the facility) required for the user 5 to select the facility (step S97). When there is no facility which satisfies the above conditions, the center server informs the user of no reservable facility (step S101) and terminates its operation.

The user 5 who browses the reservation screen information on the user terminal 50 and selectively specifies a desired facility (facility name) by being prompted by such a screen representation as to say “Select a desired reservation facility”.

The center server 31, when inputting the selected input via the communication network 60 (step S98), examines the status information of the ID management DB 302, and refers to the already sold flag (S) (step S99), and confirms that the admission ticket 10 is a duly sold ticket apart from the authentication of the steps S93 and S104 (only when sales status management is made). When the flag check is OK, the facility reservation DB updating unit 316 registers the selected facility name and time zone information in the facility reservation DB 303 for its updating. Further, the facility reservation DB updating unit 316 updates by +1 the field of the current reservation number therein (step S100).

In the operational state (“on-the-day reservation” in step S91), the user places the admission ticket in the vicinity of the in-site reservation terminal 44. This causes the in-site reservation terminal 44 to wirelessly receives a polling response and to read the element ID of the RF-ID tag 100 buried in the admission ticket 10 (step S101). The input/output interface 442 reads the element ID, and the element ID transmitter 445 transmits the read element ID to the center server 31 via the communication interface 441. The center server 31, when reading the element ID, performs its authenticating operation. When the authentication is obtained, the center server 31 performs operations of steps 95 and later, whereas, when no authentication is obtained, the center server 31 terminates its operation.

When the authentication is obtained, the idle time zone searching/outputting unit 315 searches for a facility name having an idle time zone satisfying a relation of “current reservation number<reservation available number” and outputs it (step S96). And the basis of the facility name searched and outputted by the reservation screen information generating/outputting unit 318, the idle time zone searching/outputting unit 315 generates reservation screen information required for the user 5 to select the facility, and transmits it (step S97). The reservation screen information thus generated is received by the reservation screen information receiving unit 443 via the communication interface 441.

The reservation screen information received by the reservation screen information receiving unit 443 is supplied to the display controller 446, which in turn visually displays the current location and an array of facilities installed in the vicinity thereof in such a button represented form that the user can selectively input as shown in FIG. 11, or visually displays them in the form of such a map that the already-reserved facility is displayed as distinguished from the other facilities and thus the user 5 can easily select the desired facility as shown in FIG. 12.

The user 5, who browses on the liquid crystal touch panel of the in-site reservation terminal 44, selectively specifies the desired facility by touching the panel. In the case of the reservation screen shown in FIG. 11, the user can selectively specify the desired facility by touching a desired button. In the case of the reservation screen shown in FIG. 12, the user can selectively specified the desired facility by touching the internal area of a desired balloon. The input information selected by the user 5 is inputted to the selection input information communication unit 444 and transmitted to the center server 31 via the communication interface 441.

In the exemplary screen arrangement of FIG. 12, the already-reserved facility is displayed as distinguished from the other reservation facilities by color (in a hatched area) or the like (an area B is selected in FIG. 12).

The center server 31, which receives the input information selected by the step S98 via the communication network 60, examines the status information of the ID management DB 302, refers to the already-admitted flag (E) (step S99) and confirms that the admission ticket 10 is already used to enter the event site 4. And the facility reservation DB updating unit 316 registers the selected facility name and time zone information in the facility reservation DB 303. Simultaneously with it, the facility reservation DB updating unit 316 updates the value of the field of the current reservation number in the facility reservation DB 303 by +1 (step S100).

When the user enters the event site 4 or an in-site facility, the admission monitoring unit 314 inputs the element ID of the RF-ID tag 100 buried in the admission ticket 10 via the event site entrance gate 42 or entrance gate 43, refers to facility reservation information registered in the facility reservation DB 303 with use of the ID as a key, and performs gate control to admit or refuse the entrance. The gate control may be carried out by the side of the event site 4 (in-site server 41) or by the center server 31 of the reservation center 3. In any of the previous reservation and on-the-day reservation, further, the input or notification of the admission ticket ID, the input or notification of the facility name to be reserved, etc. may be prompted by means of voice guidance.

Meanwhile, reservation confirmation is carried out according to a procedure which follows. That is, facility reservation is carried out through the aforementioned procedure, and the contents thereof is registered and stored in the facility reservation DB 303.

And the operation for the reservation confirmation is carried out, but this is carried out by the user who operates the user terminal 50 and enters the admission ticket ID printed on the admission ticket 10. At this time, such a screen as to prompt the user to input the admission ticket ID, saying “Input the admission ticket ID” appears on the user terminal 50. In response to it, the center server 31 refers to the facility reservation DB 303 to search it with use of the admission ticket ID inputted by the user as a key. Already-reserved information (facility reservation date, time zone thereof) of the user 5 searched and obtained is transmitted to the user terminal 50 via the communication network 60 and displayed on the screen. At this time, a message saying “Confirm the reserved contents” appears on the screen together with already-reserved information. The user can confirm the reserved contents by browsing the contents displayed on the screen.

When the user terminal 50 is equipped with a reader for reading the element ID of the RF-ID tag 100 buried in the admission ticket 10, such an arrangement may be allowed that it is unnecessary for the user to input the admission ticket ID as mentioned above, the reader can-read the element ID and can confirm the reserved contents from the admission ticket ID corresponding to the element ID.

After the user enters the site, the admission ticket 10 is read by the in-site reservation terminal 44 so that the element ID of the RF-ID tag 100 buried in the admission ticket 10 is read, the center server 31 is accessed via the in-site server 41 with use of the element ID as a key, and the facility reservation DB 303 is similarly referred to for searching. Even in this case, upon reading of the admission ticket, such a guidance message saying “Place the admission ticket at the predetermined position” appears on the in-site reservation terminal 44, as in the above case.

The already reserved information (facility reservation date and time zone thereof) searched for and obtained in the facility reservation DB 303 is sent to the in-site reservation terminal 44 via the in-site server 41 and displayed on the screen. Even at this time, such a guide message as to say “Confirm the reserved contents” appears on the screen together with the already-reserved information. The user (visitor) can confirm the reservation by browsing the contents displayed on the screen of the in-site reservation terminal 44 in a simple manner.

As has been explained above, in the present embodiment, since the paper ticket is processed as an electronic ticket to carry out individual ID management over the admission tickets, smooth passage of the entrance gate (touch & go passage or nonstop passage) can be realized. Further, restraints in conventional reservation can be discarded, a high quality of facility reservation service using the admission paper ticket can be realized, and reservation confirmation required for the facility reservation service can be easily conducted on the user terminal 50 or on the in-site reservation terminal 44 installed in the site.

Although explanation has been made in connection with the second identifier used as the name of the admission ticket ID in the embodiment, the name of the second identifier may be an ID used upon reservation, i.e., an ID for reservation. Further, the admission ticket 10 may have such a name as called ‘use ticket’.

The user 5 can always confirm that the reservation made by himself is surely accepted by the reservation center 3 or confirm the contents (reserved date, reserved facility, time zone, etc.) of reservation made by himself, by using the user terminal 50 or in-site reservation terminal 44.

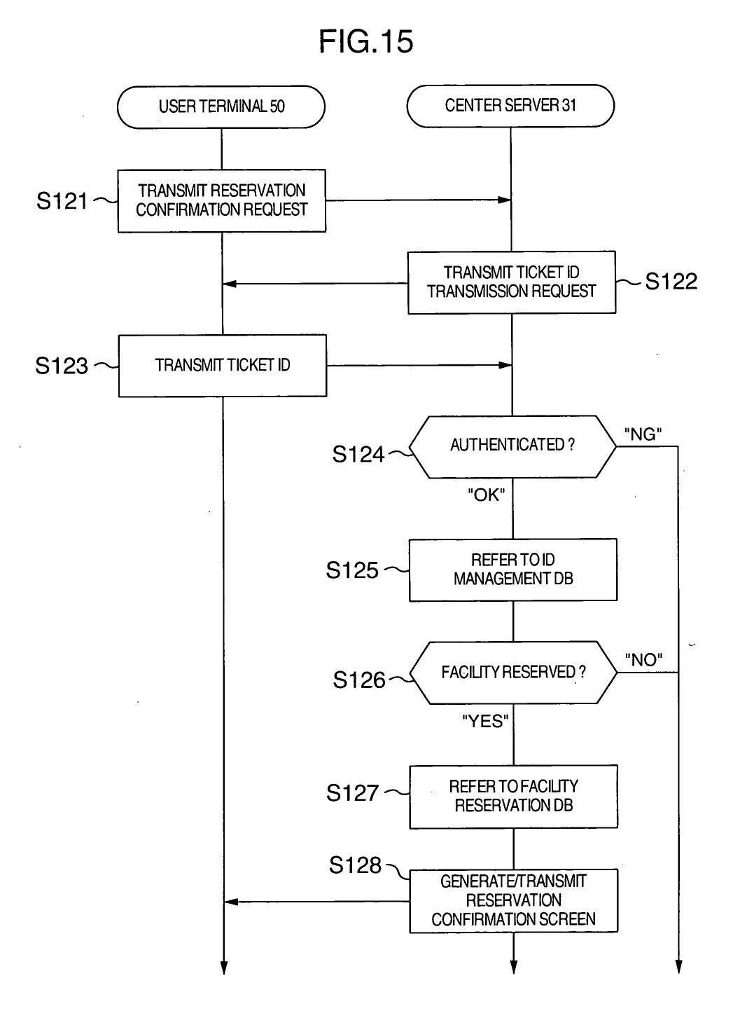

The above processing procedure will be explained according to a sequence diagram of FIG. 15 by referring to FIG. 1 and so on. When the user confirms his reservation with use of the user terminal 50, the user transmits a reservation confirmation request from the user terminal 50 (step S121). The center server 31 receives the reservation confirmation request via the communication network 60 and communication interface 311. The center server 31 when receiving the reservation confirmation request requires the user to enter the admission ticket ID (step S122). As a result, a screen prompting the user to enter the admission ticket ID appears (not shown) on the user terminal 50. The user 5 enters the admission ticket ID through a keyboard or the like and the user terminal 50 transmits the entered admission ticket ID (step S123). The center server 31 receives the admission ticket ID. As mentioned above, since the admission ticket ID is attached by an additional codes, the center server 31 performs its authenticating operation based on the admission ticket ID having the additional code attached thereto (step S124). When the authentication is NG, the center server 31 performs no operations of a step S125 and subsequent steps. When the authentication is OK, on the other hand, the center server 31 refers to the ID management DB 302 (step S125) and examines whether or not reservation is already made over the admission ticket ID (step S126). When the reservation is not made (NO), the center server.31 performs no operations of a step S127 and subsequent steps. When the reservation is made (YES), the center server 31 refers to the facility reservation DB 303 (step S127) and extracts its reservation contents therefrom. And the center server 31 generates a reservation screen and transmits it to the user terminal 50. As a result, such a reservation confirmation screen with, e.g., reservation date, facility name, time zone information, and so on as parameters (saying Mr. or Mrs. *** reserved: date; year/month/day (weekday), reservation facility; ** facility, time zone; AM **:00-AM**:00) appears on the user terminal 50. Reservation inquiry may be informed to the user 5 by generating a number for the reservation inquiry, so that the user 5 can confirm the reservation based on the inquiry number in place of or together with the admission ticket ID. Further, cookie may be used to omit the input of the admission ticket ID. In this connection, the inquiry number and cookie are both stored in the admission ticket ID as associated with each other. The inquiry may also be carried out by voice or through key button operation.

When a defect occurs in the RF-ID tag 100 buried in the admission ticket 10, this causes no problem in the previous reservation based on the notification and input of the admission ticket ID. However, this causes the element ID not to be read by, e.g., through the event site entrance gate 42 or entrance gate 43. As a result, the user 5 holding the admission ticket 10 cannot enter the event site 4 or cannot enter the reserved facility. Further, the ticket holder cannot make on-the-day reservation over a facility through the in-site reservation terminal 44.

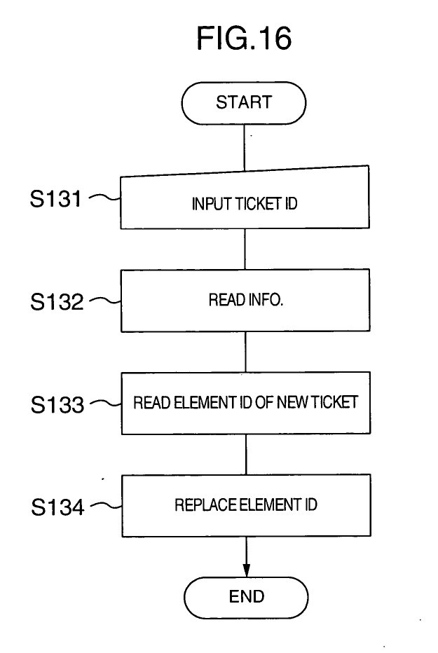

An example of how to cope with the above problem will be explained with use of the flow chart of FIG. 16 by referring to FIG. 1 and so on. More specifically, when the user 5 holds such an admission ticket 10 that cannot allow the user 5 to pass, e.g., through the event site entrance gate 42, he brings the admission ticket 10 having such a defect to, e.g., a service window or counter installed in the event site 4. When the attendant of the counter confirms the presence or absence of a defect in the RF-ID tag 100. When the attendant confirms a defect in the RF-ID tag 100, he inputs the admission ticket ID marked on the defective admission ticket 10 in a terminal (not shown) provided at the service counter using a keyboard or the like (step S131). The input of the admission ticket ID causes the terminal to read out information stored as associated with the admission ticket ID (admission ticket 10) from the admission ticket ID DB 301 or facility reservation DB 303 in FIG. 3, and to temporarily store it in the memory (step S132). On the other hand, the attendant prepares a new admission ticket 10 and reads out the element ID of the new admission ticket 10 using an element ID reader provided to the terminal (step S133). He stores the read-out element ID of the new admission ticket 10 and information read out from the admission ticket ID DB 301 or the like in the admission ticket ID DB 301 or facility reservation DB 303 as associated with each other. That is, the element ID is a sort of replaced (step S134). And the attendant the user 5 hands the new admission ticket 10 to the user 5 (the admission ticket 10 is exchanged). Since the new admission ticket 10 inherits the information stored as associated with the defective admission ticket 10 (element ID), the new admission ticket 10 can be used and processed similarly to the old admission ticket 10. In this connection, the step S133 may be located before or after the step S131.

The admission control system or reservation confirming system of the present invention is assumed to be implemented by reading programs recorded in a recording medium into a computer system and executing the programs. More specifically, the programs to be executed at the communication interface 311, authentication unit 312, reservation information registering unit 313, admission monitoring unit 314, idle time zone searching/outputting unit 315, facility reservation DB updating unit 316, Gr. reservation receiving unit 317, reservation screen information generating/outputting unit 318, communication interface 441, input/output interface 442, reservation screen information receiving unit 443, selection input information communication unit 444, element ID transmitter 445 and display controller 446 shown in FIGS. 3 and 6 respectively are recorded in the recording medium readable by a computer. The ‘computer system’ as used herein includes hardware such as an operating system (OS) or a peripheral device.

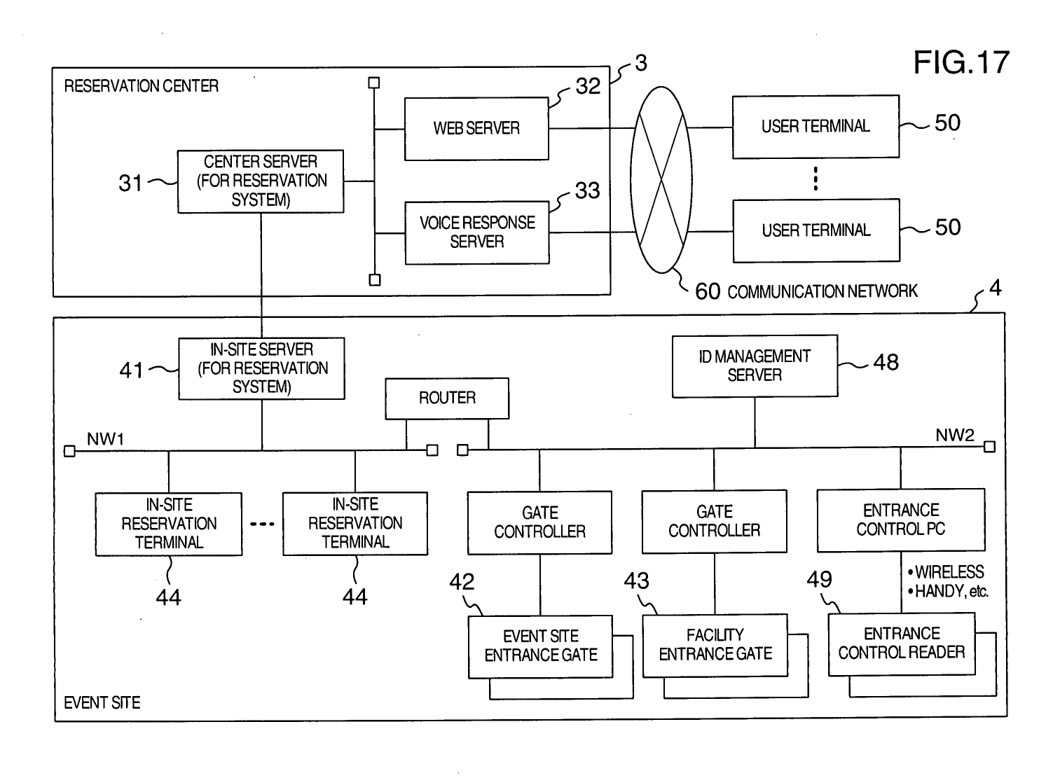

FIG. 17 is a diagram showing a connection relationship between servers, devices and so on for reference. Such servers and devices may be located as illustrated. In this drawing, the in-site reservation terminals 44 are connected to the in-site server 41 in a LAN form. An ID control server 48 for controlling the element ID or admission ticket ID is connected to the in-site server 41 via a router. Connected to the ID control server 48 via gate controllers are the event site entrance gate 42 and entrance gate 43 in a LAN form. Also connected to the ID control server 48 in a wireless manner is an entrance control reader 49 via an entrance control PC. When the reservation center 3 is installed within the event site 4, the in-site server 41 for example can be omitted. It is also possible to combine networks NW1 and NW2 into a single in-site LAN.

As has been explained in the foregoing, since the paper-made admission ticket 10 can be processed as an electronic ticket, it is environment friendly. Further, since the admission or refusal of entrance into the facility can be controlled based on the relationship among the admission ticket ID printed on the ticket paper sheet, the unique element ID of the RF-ID tag 100, and the current status of the admission ticket ID, smooth passage control over the event site entrance gate 42 or 43 to the visitors (users) can be realized. Furthermore, a plurality of facilities can be reserved at a time, and reservation confirmation required in connection with the reservation can be made in a simple manner at any time after the reservation.

In accordance with the present invention, since the admission ticket has the first identifier of the information memory element and the second identifier of the print (mark), there can be offered a service which is convenient to both of users (persons who make reservation) and persons who manage or control the event.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An admission control method for controlling entrance into a site or into a facility installed in the site on the basis of an admission ticket having an information memory element mounted therein with a first identifier capable of being identified by a computer and also having a second identifier marked on one side of the ticket, said method comprising the steps of:
registering said first identifier and facility reservation information generated as associated with said second identifier in a facility reservation DB as associated with each other; and
referring to said facility reservation DB with use of said first identifier corresponding to said admission ticket as a key to control the entrance of the facility installed in said site.

2. The admission control method according to claim 1, wherein said second identifier includes at least a serial number and an additional code, and a combination of said serial number and said additional code inputted following said serial number is authenticated to control the entrance into said facility.

3. The admission control method according to claim 1, wherein an admission ticket DB in which information about at least one of statuses of the admission ticket of already sold, already entered in the site and already reserved the facility is stored is referred to for said each second identifier to control the status of said admission ticket.

4. The admission control method according to claim 1, wherein said facility reservation information contains a reservation facility name and reservation time zone information associated therewith, and a service is offered differently for each user on the basis of private information of the user inputted at the time of registering the facility reservation information.

5. An admission control method for controlling entrance into one or more facilities installed in a site on the basis of an admission ticket having an information memory element mounted therein with a unique first identifier capable of being identified by a computer and also having a unique second identifier marked thereon and capable of being identified by a person, said method comprising the steps of:
providing a display screen to a user terminal connected via a communication network to prompt a user to input the second identifier marked on said admission ticket;
receiving said input second identifier and authenticating the correct user based on the second identifier;
when said authentication is obtained, providing the display screen to said user terminal and prompting the user to input a facility name to be reserved and a reservation time;
registering said input facility name and said input reservation time in a facility reservation DB as associated with said first identifier;
reading said first identifier of said admission ticket carried by the user who wants to enter one of the facilities installed in said site; and
referring to said facility reservation DB with use of said read first identifier as a key and controlling the entrance of one of the facilities installed in the site.

6. The admission control method according to claim 5, wherein, when the reading of the first identifier from said admission ticket ends in a failure, said facility reservation DB and a admission ticket DB are updated with use of the second identifier marked on said admission ticket as a index and reissuing an admission ticket.

7. An admission control system for controlling entrance into a site or into one of facilities installed in the site on the basis of an admission ticket having an information memory element mounted therein with a first identifier capable of being identified by computer and also having a second identifier capable of being identified by a person and marked thereon, comprising:
a facility reservation DB for registering said first identifier and facility reservation information generated when a user operates a user terminal on the basis of said second identifier as associated therewith; and
an admission control device for reading said admission ticket and referring to said facility reservation DB with use of said first identifier as a key to control the entrance when the user enters said site or one of the facilities installed in the site.

8. A facility reservation confirming method for confirming a facility reservation status through a user terminal or through an in-site reservation terminal installed in a site with use of an admission ticket having an information memory element mounted therein with a first identifier capable of being identified by computer and also having a second identifier capable of being identified by a person, comprising the steps of:
registering said first identifier and facility reservation information generated by the user in a facility reservation DB as associated with each other; and
referring to said facility reservation DB with use of said first identifier as a key and outputting a facility reservation status in response to the user operation of said user terminal or the user set of said admission ticket to said terminal installed in the site so that the admission ticket is read by said in-site terminal after the user enters the site.

9. The facility reservation confirming method according to claim 8, wherein said facility reservation status is displayed in the form of a layout map having a current location and facilities installed in the vicinity thereof, already-reserved facilities being displaced together with time information as distinguished from the other facilities.

10. A facility reservation confirming method for confirming a facility reservation status through one of reservation terminals installed in a site on the basis of an admission ticket having an information memory element mounted therein with-a unique first identifier capable of being identified by computer and also having a unique second identifier capable of being identified by a person, comprising the steps of:
receiving the second identifier inputted by a user through a user terminal and authenticating the authorized user of the admission ticket based on said second identifier;
when the authentication is obtained, prompting the user to input a facility name to be reserved and a reservation time on the basis of a display screen appearing on said user terminal;
registering said facility name and said reservation time inputted by the user who operates said user terminal in a facility reservation DB as associated with said first identifier; and
referring to said facility reservation DB with use of said first identifier as a key and displaying a facility reservation status on the display screen in response to the user operation of said user terminal or the user set of said admission ticket to said in-site terminal installed in the site so that the admission ticket is read by said in-site terminal after the user enters the site.

11. A facility reservation confirming system for confirming a facility reservation status with use of an admission ticket having an information memory element mounted therein with a first identifier capable of being identified by computer, comprising:
a facility reservation DB for registering said first identifier and facility reservation information generated by a user as associated therewith; and
an in-site reservation terminal for referring to said facility reservation DB with use of said first identifier as a key and outputting a facility reservation status of the admission ticket corresponding to said first identifier.

12. An admission ticket having an information memory element mounted therein with a unique first identifier capable of being identified by computer and also having a unique second identifier marked on the ticket and capable of being identified by a person, wherein use of one or more facilities installed in a site enterable based on said admission ticket is reserved on the basis of the second identifier marked on said admission ticket inputted by a user who holds the admission ticket through a user terminal.

13. The admission ticket according to claim 12, wherein entrance in the site or in one of the facilities in the site is controlled on the basis of said first identifier associated with said second identifier.

14. An admission ticket for use in a facility reservation method for making reservation of one or more facilities installed in a site enterable based on the admission ticket, wherein said admission ticket has an information memory element mounted therein with a unique first identifier capable of being identified by computer and also having a unique second identifier capable of being identified by a person, and said first identifier is read by a reader at least when the user enters one of the facilities.

15. A reservation control system for controlling entrance reservation in a site or in one of facilities installed in the site on the basis of an admission ticket, comprising:
an ID management database for storing a first identifier stored in an information memory element mounted in said admission ticket, said first identifier being capable of being identified by computer, and a second identifier marked on one sheet side of the admission ticket as associated with each other;
a facility reservation database for storing reservation statuses of said facilities;
authenticating means, when a user wants to make reservation of said facility using said admission ticket, for authenticating said admission ticket on the basis of said second identifier;
searching means, when the authentication results in that the reservation can be made with the admission ticket, for searching said facility reservation database for a blank time for said facility to be reserved;
screen generating means, when a blank time is present as the result of the searching, for generating a display screen to make reservation of said facility; and
database updating means, when the user selects the facility to be reserved and a time zone thereof on said reservation screen, for updating contents of said facility reservation database according to the selected contents.

16. The reservation control system according to claim 15, further comprising:
entrance monitoring means, when the user enters said facility, for referring to said facility reservation database with use of said first identifier of said admission ticket as a key and when the reservation by the admission ticket is correct, for admitting entrance in said facility.

17. The reservation control system according to claim 16, wherein, when said entrance monitoring means admits the entrance of said facility, contents of said ID management database is updated with use of the first identifier of said admission ticket as a key.

18. The reservation control system according to claim 15, wherein said ID management database includes information indicative of an already-sold status, an already-site-entered, and already-facility-reserved status of the admission ticket on the basis of the first identifier of the admission ticket.

19. A computer program product to be executed in an admission control system for controlling entrance in a site or in one of facilities installed in the site on the basis of an admission ticket having an information memory element mounted therein and capable of being identified by computer and a second identifier marked thereon and capable of being identified by a person, said program comprising the codes for performing the steps of:
prompting a user to enter the second identifier marked on said admission ticket;
receiving the entered second identifier and authenticating the correct user on the basis of the second identifier;
when said authentication is obtained, providing a display screen to said user terminal an prompting the user to enter a facility name to be reserved and a reservation time therefore;
registering said entered facility name and reservation time in a facility reservation database as associated with said first identifier;
when the user enters one of the facilities installed in said site, reading said first identifier of said admission ticket carried by the user; and
referring to said facility reservation database with use of the read first identifier as a key and controlling the entrance in one of the facilities installed in the site.

20. The computer program product according to claim 19, said program further comprising the codes for performing:
the step, when the reading of the first identifier from said admission ticket ends in a failure, of updating said facility reservation database and said admission ticket DB with use of the second identifier marked on the admission ticket as a key and reissuing an admission ticket.
